(19) United States
(12) Patent Application Publication
(10) Pub. No.: US 2016/0096105 A1
(43) Pub. Date: Apr. 7, 2016

(54) Direct Thermal Variable Printing Substrate

(71) Applicant: APPVION, INC., Appleton, WI (US)

(72) Inventor: Michael Gerald Cove, Appleton, WI (US)

(73) Assignee: Appvion, Inc., Appleton, WI (US)

(21) Appl. No.: 14/505,047

(22) Filed: Oct. 2, 2014

(51) Int. Cl. A63F 3/06; B05D 7/00

(52) U.S. Cl. CPC A63F 3/0665; B05D 7/50

(57) ABSTRACT

The invention is an article and method of discretely recording confidential information especially for lottery applications and comprises:
providing a substrate assembly comprising
a) a substrate,
b) a first layer of an acid developer material coated on the substrate,
c) a meltable barrier layer applied over the acidic developer material, the meltable barrier layer being meltable in response to the applied heat of a thermal printhead or laser,
d) a scratch-off layer coated over the meltable barrier layer, and
e) pressure-sensitive microcapsules containing a dye precursor and solvent dispersed in any of the layers and, recording non-visible information by selective application of heat to the substrate assembly using a thermal printhead or laser, the barrier layer being “activated” by melting in discrete areas where heat is selectively applied from the thermal printhead or laser.

The recorded non-visible information is revealed by removing the scratch-off layer using applied pressure thereby rupturing the microcapsules enabling the dye precursor to contact the acidic developer material and form a visible color in the discrete area where the barrier layer was melted by application of heat using a thermal printhead or laser.

### BACKGROUND OF THE INVENTION

1. Field of the Invention

This invention relates to security substrates, particularly thermally imageable substrates useful for secure point of sale imaging in diverse applications such as mailers and lottery tickets.

2. Description of the Background Art

A variety of constructions of secure substrates such as lottery tickets are known. U.S. Pat. No. 6,308,991, for example, describes a lottery ticket with an authentication feature of a bar code covered by a scratch-off layer. The ticket indicia is pre-printed and covered by a scratch-off layer to obscure the pre-printed indicia.

Alternative lottery ticket designs include pull tabs that cover pre-printed indicia. Examples of such constructs are taught in U.S. Pat. Nos. 6,390,916 and 6,379,742.

A need exists to be able to securely print information indicia to a secure substrate at the point of sale to minimize the need or extent of pre-printing required and to add versatility to gaming systems.

U.S. Pat. No. 4,677,553 teaches a scratch-off opaque overlay responsive to thermal printing to print confidential information into a concealed area. Scratch-off ink of Electronek in Carlstradt, N.J. is taught as the scratch-off material.

Typical scratch-off systems are manufactured by preprinting gaming information onto a card or similar substrate which is then concealed by an over layer of an opaque, scratchable coating. This overcoating conceals the gaming data until the consumer/player scratches the surface with a sharp instrument or coin which rubs off the, often rubber based, coating to reveal the data hidden below.

The concept of most scratch-off systems is comprised of preprinting gaming information onto a card or similar substrate which is then concealed by an over layer of an opaque, scratchable coating. This overcoating will conceal the gaming data until the consumer/player scratches the overlayer layer with a sharp instrument or coin which rubs off the, often rubber based, coating to reveal the data hidden below.

This concept of preprinting gaming tickets with data creates several major industry issues.

Printing presses are available that can create random numbers (or graphics) onto a substrate such as a card stock. The printing operation will typically create a set of randomized cards (the game pieces) in large quantities as the non-winning cards. The printing press will then print a run of winning numbers or game pieces. The gaming operator will then dose the ticket population with winning tickets to meet the requirements of target gaming “odds”, or other “odds” requirements.

The dosing process is problematic as it potentially provides opportunities to “fix” the game by individuals dosing to their advantage. This is a potential security risk for the gaming operation.

When all tickets for a game are preprinted the inventory has game value only until the winning scratch-off has been identified and won. Once the buying population recognizes a winner has been found the remaining gaming pieces are redundant and become waste.

Since the tickets are preprinted, the supply chain from printer to sales outlet has to be a secure “chain of custody” to prevent unauthorized use or sale of the tickets and to prevent fraudulent use.

A partial solution to the issues above has been to print-on-demand gaming system that are able to only create the gaming ticket at the point of purchase. In this way there are no excess tickets created or inventory that has to be destroyed when the game ends. In addition there is no winning ticket dosing process involved and system security is greatly enhanced by the use of on line software solutions. The current on line lottery ticket somewhat addresses these problems except the game is not an instant win or more importantly an instant player gratification. Better solutions are needed.

There have been many attempts to use direct thermal printing as the mechanism to create the print on demand game pieces as a scratch-off ticket. Generally, the constructions are very similar in design. When direct thermal materials are used, it is desirable to image the thermally sensitive materials held within the gaming ticket yet keep the information confidential or hidden from the player since the imaging is contained within a hidden layer in the ticket construction.

A conventional thermal paper has in at least one layer a color forming dye; and acidic developer material and a low melting point waxy component known as the modifier. This layer is contained within at least two opaque layers which prevent the player or a reading device from seeing the thermal layer once it had been imaged with a heating device such as a printhead of a thermal printer. The upper layer which can be coated directly onto the thermally sensitive imaging layer is usually a rubber based opaque scratch-off layer. The designs are such that this upper layer is easily removed to reveal the gaming pieces/numbers or graphics imaged by the thermal device and contained within the thermally sensitive imaging layer.

Another variation for Instant Tickets are Pull-tabs. Where the gaming pieces are revealed by removing a hiding layer, often a laminated card, by pulling it and tearing perforations

Current thermally imaged, print on demand, instant scratch-off tickets have limitations due to the constructions. Examples of these limitations and drawback include:
a) The opaque upper scratch-off layer needs to be of a certain thickness in order to hide the imaged thermally sensitive imaging layer below. This prevents the heat from the thermal printer penetrating down into the imaging layer and creates a difficulty in matching the opacity needed to hide the image, with the energy required to image the layer.
b) A simple solution would seem to be to increase the energy on the thermal printhead. However, this often results in a ghosted image being created on the opaque layer due to the heat deformations caused by the printhead. This ghosted image is a replica of the hidden thermal gaming piece and renders the scratch-off of no value as the player can see the number as a faint image on the ticket surface.
c) Reducing energy to overcome this issue usually results in insufficient energy to create the thermal imaged game piece.
d) Similarly constructions have been devised to image the thermal coatings from the backside of the ticket using metalized opaque layers. Again it has been difficult to prevent the formation of a surface image that can be seen by the player prior to the scratch-off process.
e) Other attempted solutions have involved a multistep process whereby the thermally imaged coatings are imaged in the normal way and the thermally coated stock is laminated to an opaque material as a second step in the process.

All the above solutions, incorporating direct thermal imaging technologies, rely on the formation of the thermal image at the time of the printing of the print on demand game piece which is then later revealed by the player.

### BRIEF DESCRIPTION OF THE DRAWING

FIG. 1 is a representation of a scratch-off lottery ticket construction according to the invention.

### SUMMARY OF THE INVENTION

The present invention comprises heat sensitive recording material useful as a scratch-off lottery ticket comprising:
a) a substrate,
b) a first layer of an acidic developer material coated on the substrate,
c) a meltable barrier layer applied over the acidic developer material, the meltable barrier layer being meltable in response to the applied heat of a printing means such as a thermal printhead or laser,
d) a scratch-off layer coated over the meltable barrier layer, and
e) a plurality of microcapsules, containing a dye precursor and solvent, dispersed in any of the layers, the microcapsules being rupturable when the scratch-off layer is removed and enabling the dye precursor to contact the acidic developer material. “Coated over” is intended to include coating over an intervening layer.

The substrate can be selected from paper, film, cardboard, and the like. The dye precursor can be leuco or fluoran color former.

Typically the meltable barrier layer is a wax layer or low melt point solid or gel, melting or liquefying at a temperature able to be applied by a thermal printhead or laser.

In another aspect, the invention comprises a pressure sensitive latent image recording ticket comprising:
a) a substrate,
b) a first layer comprising a coating of an acidic developer material,
c) a second layer comprising a meltable barrier layer applied over the acidic developer layer,
d) a third layer coated over the meltable barrier layer,
e) a microencapsulated dye-precursor dispersed in any of the layers or any intermediate layer.

In another aspect, the third layer is selected from a scratch-off layer, a transparent layer, a translucent layer, or a protective top coat layer.

Optionally, any of the layers coated on the substrate can be coated on only a portion of the substrate, typically paper or film.

The pressure sensitive latent image recording ticket can include, in addition, a scratch-off layer as a top layer or as a layer coated over the meltable bather layer.

The invention also comprises a method of discretely recording latent information such as confidential information comprising:
providing a substrate assembly comprising
a) a substrate, typically of paper or film,
b) a first layer of an acid developer material coated on the substrate,
c) a meltable barrier layer applied over the acidic developer material, the meltable barrier layer being meltable in response to the applied heat of a thermal printhead,
d) a scratch-off layer coated over the meltable barrier layer, and
e) pressure-sensitive microcapsules containing a color former and solvent dispersed in any of the layers and, recording non-visible information by selective application of heat to the substrate assembly using a thermal printhead, the barrier layer melting in discrete areas where heat is selectively applied from the printing means such as thermal printhead or laser.

The method can include the additional step of revealing the recorded non-visible information such as a lottery result by removing the scratch-off layer, typically an opaque overlay, using applied pressure thereby rupturing the microcapsules enabling the dye precursor to contact the acidic developer material and form a visible color in the discrete area where the barrier layer was melted by application of heat using a thermal printhead or laser.

### DETAILED DESCRIPTION

The present invention describes a method of creating print-on-demand instant scratch-off tickets and novel scratch-off tickets by using a printing means which can be a thermal printhead or a laser for applying heat to a meltable barrier layer to initially activate acid donor sites within a layered construction which are colorless. The action of scratching off a top layer releases the internal phase electron donor material of a pressure sensitive microcapsule held within or below the scratch layer that contains chromogen such as a leuco dye material and solvent that will react with the activated areas of the acidic developer layer to generate a colored image specifically where the acidic developer was previously activated with the thermal printer.

In this invention the thermally created imaging step to activate the acid developer layer produces an invisible colorless “image” or precursor to the image and therefore does not require a highly opaque top layer which enables a very thin top layer to be applied which does not interfere with the energy transfer from the thermal printhead to the acidic developer layer. Printing means, for example, for direct thermal papers are thermal printheads. Ideally the substrate of the invention is useful with conventional thermal printheads and laser printheads, therefore able to be used with the installed base of printers and printing means which can apply heat to the substrate.

The thermal imaging head (6) consists of an array of micro-heaters called a “mesa”. When electrical energy is applied to the heated mesa it causes a rapid increase in temperature which is transmitted to the scratch-off layer (5), shown scratched off in area (9), of the instant ticket due to the intimate contact of the mesa and scratch-off layer (5). In the heated area (7) heat is transferred through the very thin scratch-off layer causing the waxy layer (4) to melt and flow becoming melted wax area (8). The design of the acidic developer layer is such that it contains paper pigment materials that absorb the waxy layer as it melts to expose the acidic developer in the acidic developer layer (3) beneath. Typically, silicas, aluminum trihydrate, calcined clays and similar materials which are known oil absorbent paper coating materials can be used.

An optional primer layer (2) can be employed between the substrate (1). The primer layer can be a binder material to aid in adhesion of acidic developer layer (3) to the substrate (1). In area (10), the wax layer has melted and absorbed into the acidic developer layer (3) exposing the acidic donor layer. Microcapsules containing color formers are dispersed in any of layers (2), (3) or (5), or optionally even in layers (1) or (5).

The thermal mesa array is able to create a latent image at the interface between the scratch-off layer and the acid donor layer through the digital addressing of the thermal mesa as the paper advances past the thermal head in much the same way as conventional thermal printing operates. The major advance in the invention is that the latent image is colorless and is present as exposed acidic developer material. The wax layer (4) is “activated” by the selective application of heat creating the latent image in the melt areas.

This first step in imaging would be conducted by the ticket issuing machine. Digital information delivered to the thermal printhead could come from a host networked system, similar to that used to generate lottery numbers in a state lottery ticket issuing machine or the data could come from a stand-alone gaming machine.

In either case the ticket is issued to the player having the gaming pieces (numbers/graphic symbols etc) imprinted invisibly in the tickets acid donor-scratch-off layer interface.

The player would then use a device to scratch-off the upper layer (scratch-off layer (5)), for example a coin or finger-nail, which removes the scratch-off layer and in the same process ruptures the pressure sensitive microcapsules to release the internal phase containing the dye precursor and solvent. This solvent is absorbed by the acidic developer layer creating a color reaction between the acidic developer materials and the dye precursor (also known as color former) to develop a dark coloration in the position of the latent image created by the thermal printhead.

Materials that can be used in the invention are typically those used for the manufacturing of thermal papers. Acidic developer materials can be bisphenolic products and other organic acids, described in more detail herein. The color formers used are similarly those used in the production of carbonless or direct thermal papers and are often leuco or fluoran based dye materials.

Solvents used in the capsules are mostly typical solvents and oils used in the design of microcapsules such as for carbonless paper production.

Binder materials can be used to create the appropriate rheology for coating and to ensure there is good cohesion of the coatings and of the key materials at the interface of the coating layers, and as a primer layer. Polymer latexes can be used as the optional primer layer.

In this invention the waxy interlayer, wax layer (4), should have good coating adhesion with the acidic developer layer (3) and provides good coverage to the acidic developer materials to prevent any unwanted discoloration through interaction with the scratch-off layer.

The coating adhesion between the scratch-off layer (5) and the waxy interlayer, wax layer (4), is carefully controlled by the choice of the wax materials, binders and release ingredients to enable the scratch-off layer to peel away from the wax layer (4) without disturbing the said wax layer from the acidic developer layer (3).

Typically the scratch-off layer could contain materials like rubber or lattices which tend to rub up when scratched.

However in an alternative design the scratch-off layer can be designed to be colorless and transparent and remain intact when scratched with a coin. In the same way as described earlier the internal phase of the capsule is released to create an image that can be viewed through this top scratch-off layer.

In a yet further alternative, the scratch-off layer can be completely removed or replaced with a second sheet akin to a CB sheet of a carbonless form The second sheet could be applied to the heat activated first sheet, that is then visibly imaged by applying the second sheet and scratching over the assembly.

Processes of microencapsulation are well known in the art. The following process can be used to form microcapsules: U.S. Pat. No. 2,730,456 describes a method for capsule formation. Other useful methods for microcapsule manufacture are: U.S. Pat. Nos. 4,001,140; 4,081,376 and 4,089,802 describing a reaction between urea and formaldehyde; U.S. Pat. No. 4,100,103 describing reaction between melamine and formaldehyde; British Pat. No. 2,062,570 describing a process for producing microcapsules having walls produced by polymerization of melamine and formaldehyde in the presence of a styrenesulfonic acid. Microcapsules in a self-contained system are taught in U.S. Pat. Nos. 2,730,457 4,197,346 and 4,873,219. In a self-contained system, microcapsules containing a chromogenic material solution, and an acid developer material, are coated on the same surface of a sheet of paper, and for purposes hereof can be in the same layer or in contiguous layers. Pressure exerted by scratching such as with a coin, or writing or typing causes the capsules to rupture and release the chromogenic material, which then reacts with co-reactant or acidic developer to produce color. Other useful processes for forming microcapsules are from urea-formaldehyde resin and/or melamine formaldehyde resin as disclosed in U.S. Pat. Nos. 4,001,140; 4,081,376, 4,089,802; 4,100,103; 4,105,823; 4,444,699 or 4,552,811. Other microencapsulation processes are taught in U.S. Pat. Nos. 6,890,592, 7,122,503, 8,071,214, 8,067,355, 8,067,089, and 7,736,695. The foregoing patents are incorporated herein by reference.

An example of image-forming color formers are colorless electron donating compounds which form color by reacting with an acidic developer material, also known as a coreactant. Representative examples of such color formers include leuco and substantially colorless compounds having a lactone, a lactam, a sulfone, a spiropyran, an ester or an amido structure in their partial skeleton such as triarylmethane compounds, bisphenylmethane compounds, xanthene compounds, fluorans, thiazine compounds, spiropyran compounds and the like.

In addition to color former, the microcapsule core material can be selected from solvents such as:
a) dialkyl phthalates in which the alkyl groups thereof have from 4 to 13 carbon atoms, e.g., dibutyl phthalate, dioctylphthalate, dinonyl phthalate and ditridecyl phthalate
b) 2,2,4-trimethyl-1,3-pentanediol diisobutyrate (U.S. Pat. No. 4,027,065)
c) ethyldiphenylmethane (U.S. Pat. No. 3,996,405)
d) alkyl biphenyls such as monoisopropylbiphenyl (U.S. Pat. No. 3,627,581)
e) C.sub.10 C.sub.14 alkyl benzenes such as dodecyl benzene
f) diaryl ethers, di(aralkyl)ethers and aryl aralkyl ethers, ethers such as diphenyl ether, dibenzyl ether and phenyl benzyl ether
g) liquid higher dialkyl ethers (having at least 8 carbon atoms)
h) liquid higher alkyl ketones (having at least 9 carbon atoms)
i) alkyl or aralky benzoates, e.g., benzyl benzoate
j) alkylated naphthalenes
k) partially hydrogenated terphenyls
l) vegetable oils, esters of vegetable oils

If desired, common diluents such as straight chain hydrocarbons can be blended with the solvents, or blend of solvents.

A modifier such as a 1,2-diphenoxyethane can be included in the acidic developer or adjacent layer or layers. Such material typically does not impart any image on its own and is not considered active in the formation of color but as a relatively low melting solid can act as a solvent to facilitate reaction between mark-forming components. Other such sensitizers are described in U.S. Pat. No. 4,531,140. Other sensitizers for example can include N-acetoacetyl-o-toluidine, phenyl-1-hydroxy-2-naphthoate, dibenzyloxalate, para-benzylbiphenyl, and the like.

The color-forming composition comprises color formers such as leuco dye or fluoran color formers in their substantially colorless state and acidic developer material also known as acidic donor material. Chromogenic materials are also known as color formers or dye precursors and the terms are used interchangeably herein. The dye precursors or chromogenic materials react with acidic developer material to express a dye color. Microcapsules can be used to contain the color former until scratching off the scratch-off layer releases the color former and solvent freeing it to contact the acidic developer material in the acidic developer layer. The microcapsules can be optionally positioned in any of the acidic developer layer, or any layer adjacent thereto, or even in more than one layer.

A substrate or sheet for purposes hereof is understood to encompass paper and synthetic webs, ribbons, tapes, belts, films, and the like. Cards are preferred These materials typically have two large surface dimensions and a comparatively small thickness dimension. Each substrate can be appropriately selected to be opaque, optically transparent or translucent or infrared transparent to fit the need or as desired and each could, itself, be colored or not. The material can be fibrous including, for example, paper and filamentous synthetic materials. It can be a film including, for example, cellophane and synthetic polymeric sheets cast, extruded, or otherwise formed.

The imaging color-forming composition chromogenic materials are preferably positioned proximate or adjacent to the developer material layer.

Various layering techniques can be optionally employed to produce a proximate relationship of the color forming composition. In manufacturing the acidic developer layer, a coating composition can be prepared which optionally can include a fine dispersion of the components, a binder material typically a polymeric material, surface active agents and other additives in an aqueous coating medium. In alternative embodiment a protective topcoat such as polyvinylalcohol or its derivatives or other binder materials can be optionally utilized in addition to or in place of a scratch-off layer. The meltable barrier layer can be a waxy layer such as natural waxes such as polyethylene waxes, Carnauba wax, synthetic waxes; and can include lubricants such as zinc stearate; wetting agents; defoamers, and antioxidants.

The various layers applied on the substrate can be applied by coating, printing, flooding, spraying, roll coating, rod coating, gravure, curtain, bill blade, spot printing, offset, air knife and the like.

Coating or layers for purposes hereof is intended to encompass any of such application techniques whether coated, printed, laminated or otherwise applied. In alternative embodiments the various layers or some of the various layers may optionally be printed or coated onto less than the entire surface of the substrate. Such spot printing enables conservation of materials, or could yield a substrate where the coating is active only in a selected are such as a selected pre-printed or pre-coated signature area.

The components of the developer material are substantially insoluble in the dispersing vehicle (preferably water) and are ground to an individual average particle size of between about 1 micron to about 10 microns, preferably less than 30 microns. A binder can be included. The binder can be a polymeric material and is substantially vehicle soluble although latexes are also eligible in some instances. The various layers can include binder and latex. Water soluble binders can include polyvinyl alcohol, hydroxy ethylcellulose, methylcellulose, methyl-hydroxypropylcellulose, starch, styrene maleic anhydride salts, modified starches, gelatin and the like. Eligible latex materials include polyacrylates, styrene-butadiene-rubber latexes, polyvinylacetates, polystyrene, and the like. The polymeric binder can be used to protect the coated layers, especially any top layer, from brushing and handling forces occasioned by storage and use of the sheet, card, ticket, or label. Binder should be present in an amount to afford such protection and in an amount less than will interfere with achieving reactive contact between color-forming reactive materials.

Coating weights can effectively be from 0.1 to 9, or even from about 3 to about 9 grams per square meter (gsm) and preferably about 3 to about 6 gsm. The practical amount of coating materials is controlled by economic considerations, functional parameters and desired handling characteristics of the finalized coated substrate.

The color formers can include any conventional chromogens such as phthalide, leucauramine and fluoran compounds. Other examples of color formers include Crystal Violet Lactone (3,3-bis(4-dimethylaminophenyl)-6-dimethylaminophthalide, U.S. Pat. No. re. 23,024); phenyl-, indolyl, pyrrolyl, and carbazolyl substituted phthalides (for example, in U.S. Pat. Nos. 3,491,111; 3,491,112; 3,491,116; 3,509,174); nitro-, amino-, amido-, sulfonamido-, aminobenzylidene-, halo-, anilino-substituted fluorans (for example, in U.S. Pat. Nos. 3,624,107; 3,627,787; 3,641,011; 3,642,828; 3,681,390); spirodipyrans (U.S. Pat. Nos. 3,775,424 and 3,853,869).

Other specifically eligible color formers which can be used alone or in combination include 3-diethylamino-6-methyl-7-anilino-fluoran (U.S. Pat. No. 3,681,390); 2-anilino-3-methyl-6-dibutylamino-fluoran (U.S. Pat. No. 4,510,513) also known as 3-di-n-butylamino-6-methyl-7-anilino-fluoran; 3-di-n-butylamino-7-(2-chloroanilino)fluoran; 3-(N-ethyl-N-tetrahydrofurfurylamino)-6-methyl-7-3,5′6-tris(dimethylamino)spiro[9H-fluorene-9,1′(3′H)-isobenzofuran]3′-one; 7-(1-ethyl-2-methylindole-3-yl)-7-(4-diethyl-amino-2-ethoxyphenyl)-5,7-dihydrofuro[3,4-b]pyridin-5-one (U.S. Pat. No. 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindole-3-yl)-7-(4-diethyl-amino-2-ethoxyphenyl)-5,7-dihydrofuro[3,4-b]pyridin-5-one; 3-diethylamino-7,8-benzofluoran; 3,3-bis(1-ethyl-2-methylindole-3-yl)phthalide; 3-diethylamino-7-anilinofluoran; 3-diethylamino-7-benzylaminofluoran; 3′-phenyl-7-dibenzylamino-2,2′-spirodi-[2H-1-benzopyran] and mixtures of any of the above.

Eligible acidic (or electron accepting) color-developer material include the compounds listed in U.S. Pat. No. 3,539,375 as phenolic reactive material, particularly the monophenols and diphenols. Other eligible acidic developer materials also include, without being considered as limiting, the following compounds which may be used individually or in mixtures: 4,4′-isopropylidine-diphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicylanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; bis(3-allyl-4-hydroxyphenyl) sulfone, 2,2-bis(4-hydroxyphenyl)-4-methylpentane; benzyl-4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl)pentanoate; allyl-4,4-bis(4-hydroxyphenyl)pentanoate; 3,3-bis(4-hydroxyphenyl)-pentane; 4,4-bis(4-hydroxyphenyl)heptane; 2,2-bis(4-hydroxyphenyl)-1-phenylpropane; 2,2-bis(4-hydroxyphenyl)butane; 2,2′-methylene-bis(4-ethyl-6-tertiarybutylphenol); 4-hydroxycoumarin; 7-hydroxy-4-methylcoumarin; 2,2′-methylene-bis(4-octylphenol); 4,4′-sulfonyldiphenol; 4,4′-thiobis(6-tertiarybutyl-m-cresol); methyl-p-hydroxybenzoate; n-propyl-p-hydroxybenzoate; benzyl-p-hydroxybenzoate; 4-(4-(1-methylethoxy)phenyl)sulphonyl phenol. Preferred among these are the phenolic developer compounds. More preferred among the phenol compounds are 4,4′-isopropylidinediphenol, ethyl-4,4-bis(4hydroxyphenyl)pentanoate, n-propyl-4,4-bis(4-hydroxyphenyl)pentanoate, isopropyl-4,4-bis(4-hydroxyphenyl)pentanoate, methyl-4,4-bis(4-hydroxyphenyl)pentanoate, 2,2-bis(4-hydroxyphenyl)-4-methylpentane, p-hydroxybenzophenone, 2,4-dihydroxybenzophenone, 1,1-bis(4-hydroxyphenyl)cyclohexane, and benzyl-p-hydroxybenzoate; 4-(4-(1-methylethoxy)phenyl)sulphonyl phenol and 4,4′-[1,3-phenylenebis(1-methylethylene)]bisphenol. Acidic compounds of other kind and types are eligible. Examples of such other acidic developer compounds are phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, attapulgite, hallosyte, and the like. Some of the polymers and minerals do not melt but undergo color reaction on fusion of the chromogen. Of the foregoing particularly the phenol type of compounds are more preferable acidic developer materials.

The following examples are given to illustrate some of the features of the present invention and should not be considered as limiting. In these examples all parts or proportions are by weight and all measurements are in the metric system, unless otherwise stated.

In all examples illustrating the present invention a dispersion of a particular system component was prepared by milling the component in an aqueous solution of the binder until a particle size of between about 1 micron and 10 microns was achieved. The desired average particle size typically was less than 3 microns in each dispersion.

The coatings (or layers) can be made by making separate dispersions of chromogenic material and acidic material and coating or printing same onto a substrate. The dispersions are mixed in the desired ratios and the applied to the substrate such as with a wire wound rod and dried. Other non-active (as that term is understood in this application) materials such as modifiers, fillers, antioxidants, lubricants and waxes can be added if desired. The substrate may be calendered to improve smoothness.

In the examples of the thermal response of the label stock is checked by imaging with a Group III facsimile machine. This facsimile machine used can include a SHARP 220. The color produced can be measured with a Macbeth RD514 densitometer, #106 filter. The dispersions are prepared in a quickie mill, attritor and small media mill.

### EXAMPLES

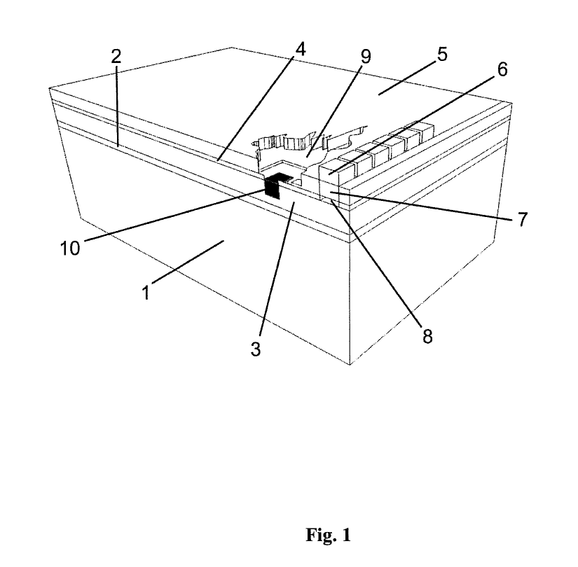

With reference to FIG. 1, a recording material according to the invention can be assembled as follows:
a) Substrate: (1) is selected from
   i) a paper substrate with a grammage range of 40-250 g/m?
   ii) possible alternatives for the examples above include coating films biaxially oriented polypropylene or high density polyethylene, in the range 40-250 g/m2
b) Layer (3) a first layer of an acid developer material is coated on the substrate,

### Example 1

Parts By Weight

| | |
|---|---|
| Color Developer, p-hydroxybenzaldephde | 6 parts |
| 10% polyvinyl alcohol | 19 parts |
| water | 10 parts |

Grind in a media mill or similar to average particle size 1 μm

### Example 2

Parts By Weight

| | |
|---|---|
| Color Developer 4,4-isopropylidinediphenol | 6 parts |
| 10% polyvinyl alcohol | 20 parts |
| water | 10 parts |
| Kaolin clay (40%) | 15 parts |

Grind in a media mill or similar to average particle size 1 μm

### Example 3

Parts By Weight

| | |
|---|---|
| Color Developer ethyl-4,4-bis (4-hydroxyphenyl pentanoate) | 34 parts |
| 10% polyvinyl alcohol | 150 parts |
| water | 10 parts |
| calcium carbonate | 34 parts |
| aluminium hydroxide 1 | 2 Parts |

Grind in a media mill or similar to average particle size 1 μm
Addition of absorptive pigments bentonite, aluminum trihydrate or calcined clay to facilitate the transfer of the microcapsule oil from the scratch layer
Any of the above can be applied to the substrate and dried to give a coating weight of 2-10 g/m2. Higher or lower coating weights can also be advantageously used.
c) Layer (4) is a meltable barrier layer applied over the acidic developer material. The meltable barrier layer meltable in response to the applied heat of a thermal printhead,

### Example 4

Parts By Weight

| | |
|---|---|
| paraffin wax emulsion (60%) | 17 parts (BYK Additives, |
| | Austin, TX - Parafine 60) |
| 10% polyvinyl alcohol | 200 Parts |

additional surfactants and defoamers are sometimes included to assist coating

### Example 5

Parts By Weight

| | |
|---|---|
| EVA emulsion (vinyl acetate - ethylene emulsion) (40%) | 87 parts |
| paraffin wax (40%) | 155 parts |
| stearic acid | 3 parts |

### Example 6

Parts By Weight

| | |
|---|---|
| acrylic emulsion (50%) | 67 parts |
| stearamide wax (40%) | 155 parts |
| stearic acid | 3 parts |

All the above formulations can be applied at coat weights of 1-5 g/m².
d) Layer (5): a scratch-off layer coated over the meltable barrier layer, and pressure-sensitive microcapsules containing a colorformer and solvent. The scratch-off layer can also be applied on press as an ink. Suitable scratch-off materials include Colorcon FGN1691 or Elecktromelt SC2900E (Carlstadt, N.J.). Other suitable scratch-off or rub-off inks include acrylic resin, water and aluminum powder dispersions, for example, G Tech U.S. Pat. No. 5,215,567 incorporated herein by reference.

### Example 7

Parts By Weight

| | |
|---|---|
| scratch off ink | 50 parts (eg Aquo Print from |
| | Spring Coating Systems) |
| microcapsules (dry) | 20 parts (1-20 μm capsules) |
| water | |

### Example 8

Parts By Weight

| | | |
|---|---|---|
| acrylic emulsion (50%) | 200 | parts |
| filler | 5-30 | part |
| capsules (dry) | 5-30 | part |

| | |
|---|---|
| water | 10-60 part (dilute to approx 50% solids) |

Wherein the filler can be 100% calcium carbonate; 100% powdered aluminum metallic or ratios of the two materials. for example 25% calcium carbonate; 75% aluminum

### Example 9

Capsule Preparation
Internal Phase
Colorformers:

| | |
|---|---|
| 3′chloro-6′-cyclohexylamino-spiro[isobenzofuran-1(3H), | 1.58% |
| 9′-[9H]xanthen]-3-one | |
| 6′-[ethyl(3-methylbutyl)amino]-3′-methyl-2-′(phenylamino)- | 2.50% |
| spiro[isobenzofuran-1(3H), 9′-[9H]xanthen]-3-one | 1.11% |
| 3-diethylamino-6-methyl-7-(2,4-dimethylphenyl)aminofluouran | |
| solvents | |
| soybean oil | 26.83% |
| canola oil methyl ester | 39.21% |
| normal paraffinic hydrocarbons (Norpar 12 solvent) | 16.51% |

Aqueous Phase I

| | |
|---|---|
| acrylic Copolymer | 2.11% |
| NaOH | 0.32% |
| melamine-formaldehyde Resin | 1.08% |

Aqueous Phase II

| | |
|---|---|
| acrylic Copolymer | 1.76% |
| 20% NaOH | 0.01% |
| melamine-formaldehyde Resin | 5.93% |
| salt | |
| Na₂SO₄ | 1.06% |

### Example 10

Using similar ratios as in Example 9, in a jacketed reactor, an acrylic butyl-acrylate copolymer, caustic, and deionized water are combined with heating to about 65° C. while mixing. The target pH for the first aqueous phase is 5.65-5.75. A colorformer, such as 3-diethylamino-6-methyl-7-(2,4-dimethylphenyl)aminofluoren is dissolved in a vegetable oil methyl ester in a jacketed first container at approximately 100° C. A second aqueous phase is prepared by combining acrylic butyl-acrylate copolymer, caustic, and deionized water in a second container. The second aqueous phase is mixed and allowed to sit at room temperature. The target pH for the second aqueous phase is 4.40-4.55. A solvent or mixture of solvents such as a mixture of soybean oil and/or normal paraffinic hydrocarbons are added to the first solution. After the addition, the temperature of the internal phase (IP) is brought to ^{˜}80° C. The IP was is allowed to cool to ^{˜}75° C., at which point melamine formaldehyde resin is then added to the reactor containing the preheated first aqueous phase. Four minutes after the melamine formaldehyde addition, the IP is added to the reactor over ^{˜}8 minutes. After this time, milling is started at 1150 fpm (mill speed can range from 1000 fpm to 1250 fpm, depending on desired capsule size, solvent ratio, solvent type and colorformer amount) and continued for 30 minutes. At the completion of 30 minutes, milling is stopped with agitation continued. An etherified methyol melamine oligomer is then added to the second water phase and allowed to mix for approximately 10 minutes before addition to the reactor. 500 g of Na₂SO₄ is added to the reactor. The batch is allowed to mix with agitation for 8 hours at 65° C., at which point the heat is discontinued. Thereafter, the batch is diluted and neutralized with NH₄OH to pH 7.5-8.25.

Capsule sizes range from 4 μm to 5.8 μm, dependent primarily on milling speed. Canola oil methyl ester can be advantageous to solvate dyes. Soybean oil can be a primary diluent. Normal paraffinic hydrocarbons (Norpar 12, Exxon Mobil, Houston, Tex.) alternatively can be a primary or secondary diluent. Rupture of the capsules would release the encapsulated solvated dyes.

Capsules of either capsule system A or B are dispersed in any of layers (2), (3) or 4 or even in layers (1) or (5). The capsules can be used at anywhere from a fraction of a percent by weight of the receptive layer or even up to three or even five percent of a layer, or more. Sufficient capsules are employed to yield the desired image, with more or less employed depending on how intense the image density is desired.

All percentages, parts, and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims.

What is claimed is:

1. A heat sensitive recording material useful as a scratch-off ticket comprising:
a) a substrate,
b) a first layer of an acidic developer material coated on the substrate,
c) a meltable barrier layer applied over the acidic developer material, the meltable barrier layer being meltable in response to heat applied from a printing means,
d) a scratch-off layer coated over the meltable barrier layer,
e) microcapsules, containing a dye precursor and solvent, dispersed in any of the layers, the microcapsules being rupturable when the scratch-off layer is removed and enabling the dye precursor to contact the acidic developer material.

2. The heat sensitive recording material according to claim 1 wherein the substrate is selected from paper or film.

3. The heat sensitive recording material according to claim 1 wherein the dye precursor is a leuco or fluoran color former.

4. The heat sensitive recording material according to claim 1 wherein the meltable barrier layer is selected from a wax, a low melt point solid, or a gel.

5. The heat sensitive material according to claim 1 wherein any of the layers coated on the substrate are coated on only a portion of the substrate.

6. The heat sensitive recoding material according to claim 1 wherein the scratch-off ticket is a lottery ticket.

7. The heat sensitive recording material according to claim 1 comprising in addition an optional printer layer.

8. A pressure sensitive latent image recording ticket comprising:
a) a substrate,
b) a first layer comprising a coating of an acidic developer material,
c) a second layer comprising a meltable barrier layer applied over the acidic donor layer,
d) a third layer coated over the meltable barrier layer,
e) a microencapsulated dye-precursor dispersed in any of the layers.

9. The ticket according to claim 8 wherein the third layer is selected from a scratch-off layer, a transparent layer, a translucent layer, or a protective top coat layer.

10. The ticket according to claim 9 wherein any of the layers coated on the substrate are coated on only a portion of the substrate.

11. The pressure sensitive latent image recoding ticket according to claim 8 wherein the substrate is paper or film.

12. The pressure sensitive latent image recording ticket according to claim 8 including in addition a scratch-off layer as a top layer or as a layer over the meltable barrier layer.

13. A method of recording latent information comprising:
providing a substrate assembly comprising:
a) a substrate,
b) a first layer of an acidic developer material coated on the substrate,
c) a meltable barrier layer applied over the acidic developer material, the meltable, barrier layer being meltable in response to the applied heat of a printing means,
d) a scratch-off layer coated over the meltable barrier layer,
e) pressure-sensitive microcapsules containing a dye precursor and solvent dispersed in any of the layers;
recording non-visible information by selective application of heat to the substrate assembly using a printing means, the barrier layer melting in discrete areas where heat is applied from the printing means.

14. The method according to claim 13 including the additional step of revealing the recorded non-visible information by removing the scratch-off layer using applied pressure thereby rupturing the microcapsules enabling the dye precursor to contact the acidic developer material and form a visible color in the discrete areas where the barrier layer melted.

15. The method according to claim 12 wherein recording the non-visible information is by selective application of heat applied from a printing means comprising a thermal printhead or laser.

16. The method according to claim 12 wherein the scratch-off layer is an opaque overlay disposed over the meltable barrier layer.

17. The method according to claim 12 wherein the recording of non-visible information comprises recording of a lottery result.
